(19) United States
(12) Patent Application Publication
(10) Pub. No.: US 2026/0338241 A1
(43) Pub. Date: Oct. 29, 2026

(54) BRAKE APPARATUS FOR VEHICLE

(71) Applicant: HYUNDAI MOBIS CO., LTD., Seoul (KR)

(72) Inventors: Hyun Hwa HONG, Yongin-si (KR); Byeong Jun OH, Yongin-si (KR); Ho Hyoung PARK, Yongin-si (KR); Moo Jin CHOI, Yongin-si (KR)

(73) Assignee: HYUNDAI MOBIS CO., LTD., Seoul (KR)

(21) Appl. No.: 19/403,628

(22) Filed: Nov. 28, 2025

(30) Foreign Application Priority Data
Mar. 12, 2025 (KR) 10-2025-0032189

(51) Int. Cl. F16D 65/00; F16D 65/18

(52) U.S. Cl. CPC F16D 65/0068; F16D 65/183; F16D 65/0031

(57) ABSTRACT

The present disclosure relates to a brake apparatus for a vehicle including: a service braking part; a parking braking part movably disposed in the service braking part and provided with a guide; a guide rod inserted into the guide to guide movement of the parking braking part in a first direction or in a direction opposite to the first direction; and a fastening member fastened to the service braking part by passing through the guide rod.

### CROSS-REFERENCE TO RELATED APPLICATION

This application claims priority from and the benefit of Korean Patent Application No. 10-2025-0032189, filed on Mar. 12, 2025, which is hereby incorporated by reference for all purposes as if set forth herein.

### BACKGROUND

### Field

Exemplary embodiments of the present disclosure relate to a brake apparatus for a vehicle, and more particularly, to a brake apparatus for a vehicle in which a floating-type caliper is integrally provided with a fixed-type caliper.

### Description of the Related Art

A fixed-type (opposed-type) caliper is a type in which pistons are disposed inside and outside a brake disc. Although manufacturing cost of the fixed-type caliper is higher than that of a floating-type caliper, the fixed-type caliper offers better rigidity, superior braking responsiveness, uniform surface pressure, and aesthetically pleasing appearance, compared to the floating-type caliper. Accordingly, the fixed-type caliper is primarily applied to a premium or high-performance vehicle.

A floating-type caliper is configured such that a torque member and a caliper body move relative to each other (slide) through a guide pin and sliding hole structure. When the guide pin is formed on the caliper body side and the sliding hole is formed on the torque member side, it is referred to as a Colette (CL)-type, whereas when the guide pin is formed on the torque member side and the sliding hole is formed on the caliper body side, it is referred to as a Colette Reverse (CR)-type.

In general, when the fixed-type caliper is applied to a vehicle's rear-wheel brake disc, a separate system for parking braking should be added. Recently, in order to reduce system weight and the number of components, an integrated fixed-type caliper electronic parking brake (EPB) has been developed, in which a parking function is integrated into a single system together with the fixed-type caliper.

The related art of the present disclosure is disclosed in Korean Patent Application Publication No. 10-2024-0051636 (published on April 22, 2024 and entitled “BRAKE DEVICE, BRAKE SYSTEM AND VEHICLE”).

### SUMMARY

Various aspects of the present disclosure provide a brake apparatus for a vehicle, which may be configured as an integrated unit by applying a fixed-type caliper for service braking and a floating-type caliper for parking braking.

A brake apparatus for a vehicle according to the present disclosure, the brake apparatus includes: a service braking part; a parking braking part movably disposed in the service braking part and provided with a guide; a guide rod inserted into the guide to guide movement of the parking braking part in a first direction or in a direction opposite to the first direction; and a fastening member fastened to the service braking part by passing through the guide rod.

The brake apparatus may further include a dust boot coupled to the guide and disposed on both sides of the guide rod.

The service braking part may include: a service braking caliper body; a first brake pad movably disposed in a first region of the service braking caliper body and capable of coming into contact with the parking braking part; and a second brake pad movably disposed in a second region, configured to face the first region, of the service braking caliper body and capable of coming into contact with the parking braking part.

The service braking part may further include a guide pin provided in the service braking caliper body, wherein the first brake pad and the second brake pad are movably coupled to the guide pin, such that the guide pin guides movement of the first brake pad and the second brake pad.

The service braking caliper body may include: a first groove concavely formed in the first region to expose at least a portion of the first brake pad; and a second groove concavely formed in the second region to expose at least a portion of the second brake pad.

The service braking caliper body may further include a movement restricting portion provided in the first region and configured to interfere with the parking braking part and restrict movement of the parking braking part in the direction opposite to the first direction.

The parking braking part may include: a parking caliper body provided with a parking cylinder disposed to face the second brake pad; a parking piston movably disposed in the parking cylinder and capable of coming into contact with the second brake pad; a drive unit coupled to the parking caliper body and configured to generate rotational force; and a power transmission member rotatably disposed in the parking cylinder and configured to receive the rotational force from the drive unit and move the parking piston.

The parking piston may be coupled to the power transmission member and move in the first direction or in the direction opposite to the first direction in conjunction with rotation of the power transmission member.

The parking piston may move in the direction opposite to the first direction to press the second brake pad.

The parking braking part may include a finger configured to extend from the parking caliper body, disposed to face the first brake pad, and configured to press the first brake pad in response to the parking caliper body moving in the first direction.

The present disclosure may implement an electronic parking brake (EPB) that uses a fixed-type caliper for service braking to enhance braking performance and uses a floating-type caliper to operate parking braking.

The present disclosure may utilize a service braking caliper body as a torque member of a parking caliper body during parking braking.

The present disclosure may replace the guide rod of a conventional Colette (CL)-type with a guide rod of a Colette Reverse (CR)-type structure to connect the service braking caliper body and the parking caliper body, thereby securing a stable center of gravity and enhancing behavioral stability of the parking caliper body to improve durability and dynamic braking performance.

### BRIEF DESCRIPTION OF THE DRAWINGS

FIG. 1 is a perspective view illustrating a brake apparatus for a vehicle according to embodiments of the present disclosure, when viewed from above.

FIG. 2 is a perspective view illustrating the brake apparatus for a vehicle in FIG. 1, when viewed from below.

FIG. 3 is a perspective view illustrating a service braking part of the brake apparatus for a vehicle according to embodiments of the present disclosure, when viewed from above.

FIG. 4 is a cross-sectional view taken along line IV-IV in FIG. 3.

FIG. 5 is a cross-sectional view taken along line V-V in FIG. 1.

FIG. 6 is an exploded perspective view illustrating the brake apparatus for a vehicle according to embodiments of the present disclosure.

FIG. 7 is a cross-sectional view taken along line VI-VI in FIG. 1.

FIG. 8 is a cross-sectional view illustrating an operating state of the brake apparatus for a vehicle according to embodiments of the present disclosure.

### DETAILED DESCRIPTION

Hereinafter, a brake apparatus for a vehicle will be described with reference to the accompanying drawings through various exemplary embodiments. In this process, the thickness of lines or the size of components shown in the drawings may be exaggerated for clarity and convenience of explanation. In addition, the terms as used herein are defined in consideration of functions thereof in the present disclosure, and this may change depending on a user or operator’s intention or practice. Therefore, these terms should be defined based on the entirety of the disclosure set forth herein.

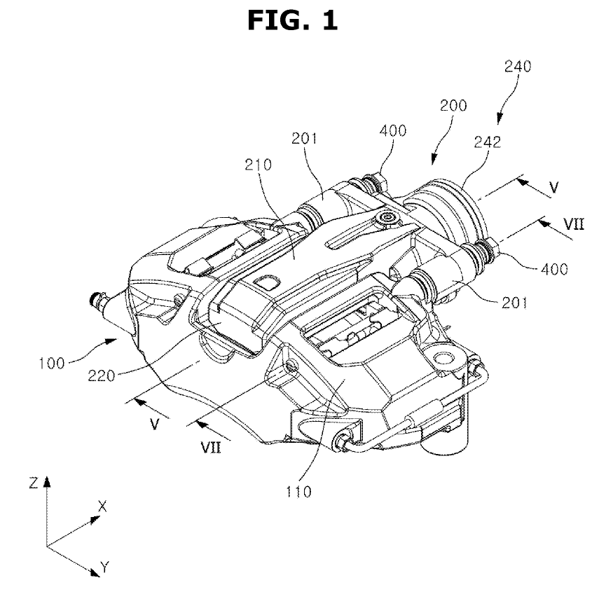

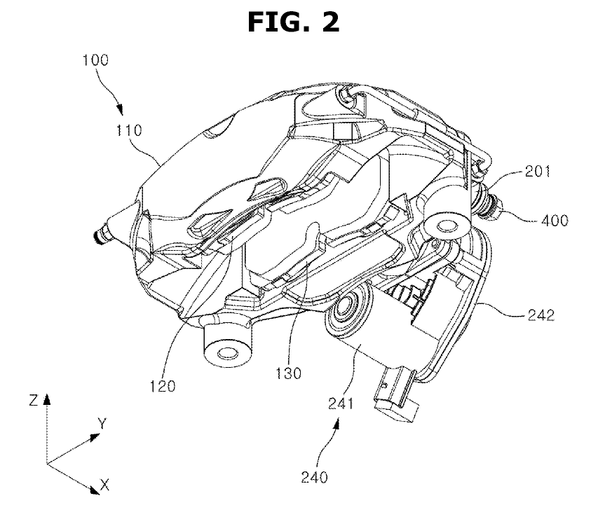

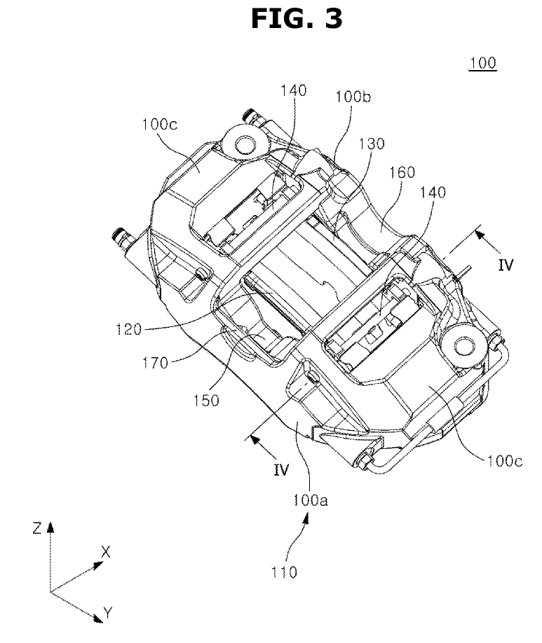

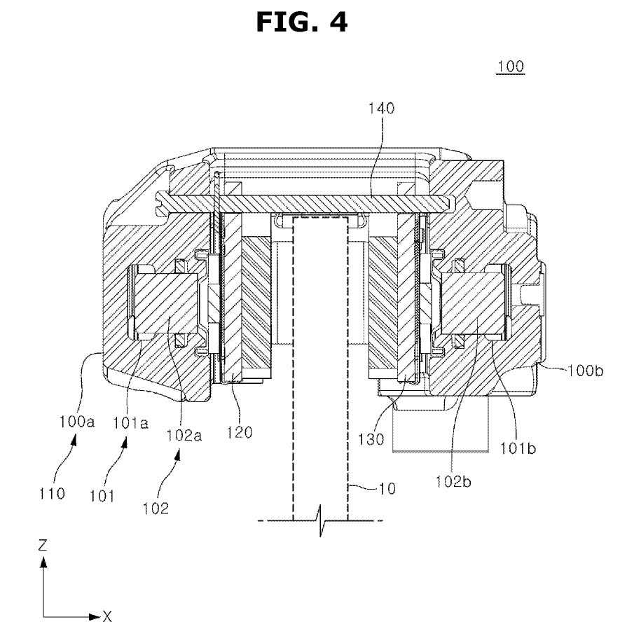

FIG. 1 is a perspective view illustrating a brake apparatus for a vehicle according to embodiments of the present disclosure, when viewed from above. FIG. 2 is a perspective view illustrating the brake apparatus for a vehicle in FIG. 1, when viewed from below. FIG. 3 is a perspective view illustrating a service braking part of the brake apparatus for a vehicle according to embodiments of the present disclosure, when viewed from above. FIG. 4 is a cross-sectional view taken along line IV-IV in FIG. 3.

Referring to FIGS. 1-4, a brake apparatus for a vehicle according to embodiments of the present disclosure includes a service braking part 100, a parking braking part 200, a guide rod 300, and a fastening member 400, which will be described in detail below.

Hereinafter, a first direction may refer to a direction in which the X-axis is oriented with respect to FIG. 1; a second direction may refer to a direction in which the Y-axis is oriented with respect to FIG. 1; and a third direction may refer to a direction in which the Z-axis is oriented with respect to FIG. 1.

The service braking part 100 according to the present embodiment may include a service braking caliper body 110, a first brake pad 120, and a second brake pad 130.

The service braking caliper body 110 may form an overall exterior appearance of the service braking part 100, and may support as a whole the first brake pad 120 and the second brake pad 130. The service braking caliper body 110 may be secured to a knuckle (not illustrated) or the like of a vehicle.

The service braking caliper body 110 according to the present embodiment may be provided with a service braking cylinder 101. The service braking cylinder 101 may be provided inside the service braking caliper body 110. The service braking cylinder 101 may be formed in a hollow shape with one side open. The service braking cylinder 101 may include a first cylinder 101a and a second cylinder 101b.

The service braking caliper body 110 according to the present embodiment may include a first region 100a, a second region 100b, and a connecting portion 100c.

The first region 100a may be provided with the first cylinder 101a. An open side of the first cylinder 101a may be disposed to face the first brake pad 120. A plurality of the first cylinders 101a may be provided. The plurality of the first cylinders 101a may be disposed to be spaced apart from each other along a direction parallel to the second direction.

The second region 100b may be disposed to face the first region 100a. The first region 100a and the second region 100b may be disposed to be spaced apart from each other along a direction parallel to the first direction.

The second region 100b may be provided with the second cylinder 101b. An open side of the second cylinder 101b may be disposed to face the second brake pad 130. A plurality of the second cylinders 101b may be provided. The plurality of the second cylinders 101b may be disposed to be spaced apart from each other along the direction parallel to the second direction.

The first brake pad 120 may be movably disposed in the first region 100a, and the second brake pad 130 may be movably disposed in the second region 100b. The first brake pad 120 and the second brake pad 130 may come into contact with the parking braking part 200.

The first brake pad 120 and the second brake pad 130 may be disposed between the first region 100a and the second region 100b. The first brake pad 120 and the second brake pad 130 may be disposed to face each other with a brake disc 10 interposed therebetween.

The first brake pad 120 facing the first cylinder 101a may be disposed to be spaced apart from the brake disc 10 along a direction opposite to the first direction, and the second brake pad 130 facing the second cylinder 101b may be disposed to be spaced apart from the brake disc 10 along the first direction.

A friction pad including a material having a high friction coefficient, such as rubber, may be attached to one surface of the first brake pad 120 and the second brake pad 130 facing the brake disc 10.

A service braking piston 102 may be accommodated inside the service braking cylinder 101 according to the present embodiment. The service braking piston 102 may include a first piston 102a and a second piston 102b.

The first piston 102a may be movably installed in the first cylinder 101a. The first piston 102a may be disposed inside the first cylinder 101a. The first piston 102a may reciprocate linearly along an axial direction of the first cylinder 101a, which is parallel to the first direction.

An outer surface of the first piston 102a may be supported on an inner surface of the first cylinder 101a to be slidably movable. Alternatively, the outer surface of the first piston 102a may be spaced apart a set distance from the inner surface of the first cylinder 101a to form a clearance.

As the first piston 102a moves outward from the first cylinder 101a, the first piston 102a may protrude from the first cylinder 101a and press the first brake pad 120, which is disposed to face the first cylinder 101a, toward the brake disc 10. That is, as the first piston 102a moves in the first direction, the first piston 102a may press the first brake pad 120, which is disposed to face the first cylinder 101a, toward the first direction.

The second piston 102b may be movably installed in the second cylinder 101b. The second piston 102b may be disposed inside the second cylinder 101b. The second piston 102b may reciprocate linearly along an axial direction of the second cylinder 101b, which is parallel to the first direction. The second piston 102b may move together with the first piston 102a in opposite directions to each other.

An outer surface of the second piston 102b may be supported on an inner surface of the second cylinder 101b to be slidably movable. Alternatively, the outer surface of the second piston 102b may be spaced apart a set distance from the inner surface of the second cylinder 101b to form a clearance.

As the second piston 102b moves outward from the second cylinder 101b, the second piston 102b may protrude from the second cylinder 101b and press the second brake pad 130, which is disposed to face the second cylinder 101b, toward the brake disc 10. That is, as the second piston 102b moves in the direction opposite to the first direction, the second piston 102b may press the second brake pad 130, which is disposed to face the second cylinder 101b, toward the direction opposite to the first direction.

The service braking part 100 according to the present embodiment may further include a guide pin 140.

The guide pin 140 may be provided in the service braking caliper body 110. The guide pin 140 may be coupled to the first region 100a and the second region 100b of the service braking caliper body 110 by passing through the first brake pad 120 and the second brake pad 130 in the direction parallel to the first direction.

A plurality of the guide pins 140 may be provided. The plurality of the guide pins 140 may be disposed to be spaced apart from each other along the direction parallel to the second direction.

The first brake pad 120 and the second brake pad 130 may be movably coupled to the guide pin 140. The first brake pad 120 and the second brake pad 130 may be supported on the guide pin 140 to be slidably movable in the direction parallel to the first direction. The guide pin 140 may guide movement of the first brake pad 120 and the second brake pad 130 in the first direction or in the direction opposite to the first direction.

The service braking part 100 according to the present embodiment may include a first groove 150 and a second groove 160.

The first groove 150 may be provided in the first region 100a of the service braking caliper body 110. The first groove 150 may be formed concavely downward from an upper surface of the first region 100a (as shown in FIG. 3).

At least a portion of the first brake pad 120 may be exposed due to the first groove 150 formed concavely in the first region 100a of the service braking caliper body 110. Through the first groove 150, the first brake pad 120 may come into contact with the parking braking part 200 and be pressed by the parking braking part 200.

The second groove 160 may be provided in the second region 100b of the service braking caliper body 110. The second groove 160 may be formed concavely downward from an upper surface of the second region 100b (as shown in FIG. 3).

At least a portion of the second brake pad 130 may be exposed due to the second groove 160 formed concavely in the second region 100b of the service braking caliper body 110. Through the second groove 160, the second brake pad 130 may come into contact with the parking braking part 200 and be pressed by the parking braking part 200.

The service braking part 100 according to the present embodiment may further include a movement restricting portion 170.

The movement restricting portion 170 may be provided in the first region 100a of the service braking caliper body 110. The movement restricting portion 170 may protrude upward from an outer edge of the first groove 150 above the first region 100a.

The movement restricting portion 170 may be disposed to face the first brake pad 120 along the direction parallel to the first direction. The movement restricting portion 170 may be disposed to be spaced apart from the first brake pad 120 in the direction parallel to the first direction.

The movement restricting portion 170 may restrict movement of the parking braking part 200. The movement restricting portion 170 may interfere with the parking braking part 200 and restrict movement of the parking braking part 200 in the direction opposite to the first direction.

The parking braking part 200 may be movably disposed in the service braking part 100. The parking braking part 200 may be coupled to the service braking part 100 to be movable in the first direction or in the direction opposite to the first direction. The parking braking part 200 may be provided with a guide 201.

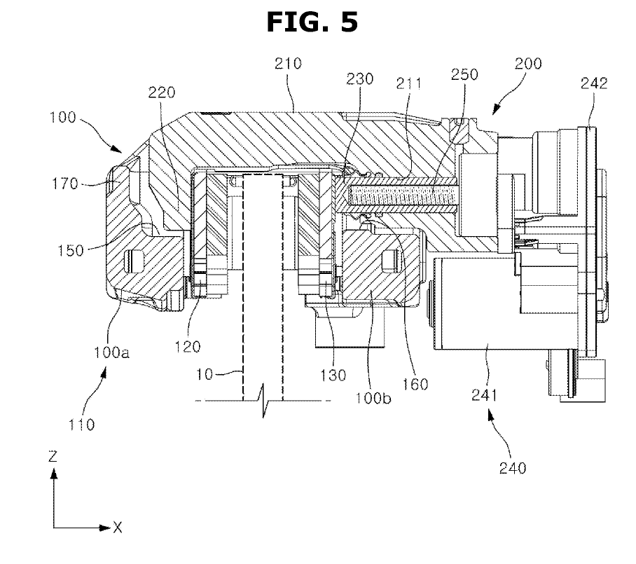

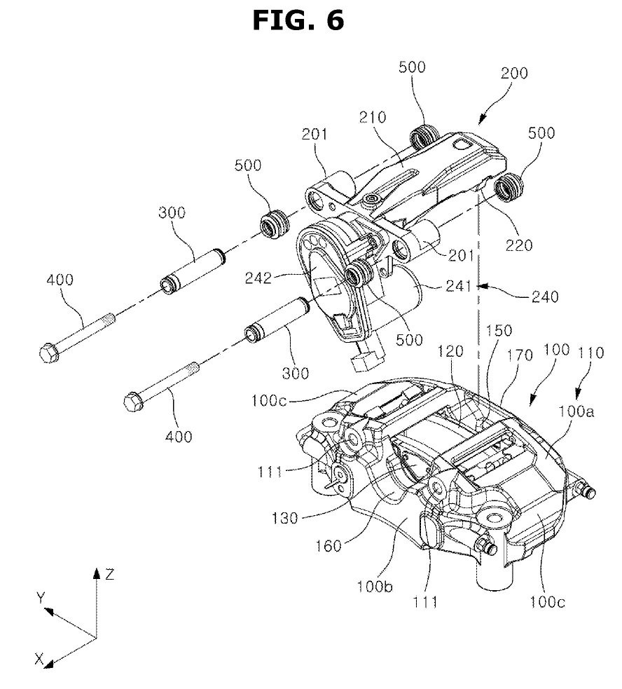

FIG. 5 is a cross-sectional view taken along line V-V in FIG. 1. FIG. 6 is an exploded perspective view illustrating the brake apparatus for a vehicle according to embodiments of the present disclosure.

Referring to FIGS. 1-6, the parking braking part 200 according to the present embodiment may include a parking caliper body 210, a parking piston 230, a drive unit 240, and a power transmission member 250.

The parking caliper body 210 may form an overall exterior appearance of the parking braking part 200, and may support as a whole the parking piston 230, the drive unit 240, the power transmission member 250.

A lower surface (as shown in FIG. 5) of the parking caliper body 210 may be disposed to face a peripheral surface of the brake disc 10 by being spaced apart a set distance from the same. Both sides of the parking caliper body 210 may extend along the first direction and the direction opposite to the first direction, respectively, with respect to the brake disc 10.

The first brake pad 120 and the second brake pad 130 may be disposed below the parking caliper body 210 (as shown in FIG. 5). The first brake pad 120 and the second brake pad 130 may be spaced apart from each other along a central axis of the brake disc 10. The first brake pad 120 and the second brake pad 130 may be disposed to face each other with the brake disc 10 interposed therebetween.

The parking caliper body 210 according to the present embodiment may be provided with the guide 201.

The guide 201 may be disposed on both sides of the parking caliper body 210 parallel to the second direction. The guide 201 may be formed in a hollow cylindrical shape, and may be formed to have a shape extending along the direction parallel to the first direction.

The parking caliper body 210 according to the present embodiment may be provided with a parking cylinder 211.

The parking cylinder 211 may extend downward from one side (the right side in FIG. 5) of the parking caliper body 210. The parking cylinder 211 may be seated on the second groove 160.

The parking cylinder 211 may be formed in a cylinder shape with a hollow interior and one side open. The open side of the parking cylinder 211 may be disposed to face the second brake pad 130.

The open side of the parking cylinder 211 may be disposed to face the second brake pad 130, which is spaced apart from the brake disc 10 in the first direction. The open side of the parking cylinder 211 may be spaced apart a set distance from the second brake pad 130, which is spaced apart from the brake disc 10 in the first direction.

A central axis of the parking cylinder 211 may be disposed parallel to the central axis of the brake disc 10. The central axis of the parking cylinder 211 may be spaced apart from the central axis of the brake disc 10 along the third direction

The parking piston 230 may be movably disposed in the parking cylinder 211. The parking piston 230 may come into contact with the second brake pad 130.

The parking piston 230 may be installed in the parking cylinder 211 to be movable in the first direction or in the direction opposite to the first direction. The parking piston 230 may be disposed inside the parking cylinder 211.

The parking piston 230 may be formed in a hollow shape with one side open. A closed side of the parking piston 230 may be disposed to be oriented toward the second brake pad 130, which is disposed to face the parking cylinder 211.

The open side of the parking piston 230 may be disposed to be oriented toward an internal space of the parking cylinder 211. An outer surface of the parking piston 230 may be supported on an inner surface of the parking cylinder 211 to be slidably movable. Alternatively, the outer surface of the parking piston 230 may be spaced apart a set distance from the inner surface of the parking cylinder 211 to form a clearance.

As the parking piston 230 moves in the direction opposite to the first direction, the parking piston 230 may protrude outward from the parking cylinder 211 and press the second brake pad 130, which is disposed to face the parking cylinder 211, toward the brake disc 10.

The drive unit 240 may be coupled to the parking caliper body 210, and may generate rotational force. The drive unit 240 according to the present embodiment may include a motor 241 and a power transmission means 242.

The motor 241 may be exemplified by various types of electric motors capable of generating rotational force by receiving power from a vehicle battery (not illustrated) or the like.

The power transmission means 242 may transmit the rotational force of the motor 241 to the power transmission member 250. The power transmission means 242 may include a plurality of gears sequentially engaged between the motor 241 and the power transmission member 250. However, the power transmission means 242 is not limited to such a configuration, and the type of the power transmission means 242, which is capable of receiving rotational force from the motor 241 and rotating the power transmission member 250, may vary with a design change.

The power transmission member 250 may be rotatably disposed in the parking cylinder 211, and may be connected to the parking piston 230. The power transmission member 250 may be connected to the power transmission means 242, which receives rotational force from the motor 241. The power transmission member 250 may transmit the rotational force of the drive unit 240 to the parking piston 230.

In response to the drive unit 240 operating, the power transmission member 250 may receive, through the power transmission means 242, rotational force generated from the motor 241, and may rotate clockwise or counterclockwise about a central axis parallel to the first direction.

The power transmission member 250 may be disposed inside the parking piston 230. The power transmission member 250 may receive the rotational force of the drive unit 240 and move the parking piston 230 in the first direction or in the direction opposite to the first direction. The power transmission member 250 may be exemplified by a ball screw or the like that converts rotational motion of the drive unit 240 into linear motion of the parking piston 230.

The parking piston 230 according to the present embodiment may be threadedly engaged with the power transmission member 250, and may move in the first direction or in the direction opposite to the first direction in conjunction with rotation of the power transmission member 250. The parking piston 230 may move in the direction opposite to the first direction to press the second brake pad 130.

The parking braking part 200 according to the present embodiment may further include a finger 220.

The finger 220 may extend downward from the other side (the left side in FIG. 5) of the parking caliper body 210. The finger 220 may be disposed to face the first brake pad 120, and may press the first brake pad 120 as the parking caliper body 210 moves in the first direction.

The finger 220 may be disposed between the movement restricting portion 170 and the first brake pad 120, and may be seated on the first groove 150. The finger 220 may be disposed to face the first brake pad 120, which is spaced apart from the brake disc 10 in the direction opposite to the first direction.

In response to the parking caliper body 210 moving along the first direction, the finger 220 may press the first brake pad 120, which is spaced apart from the brake disc 10 in the direction opposite to the first direction, toward the brake disc 10.

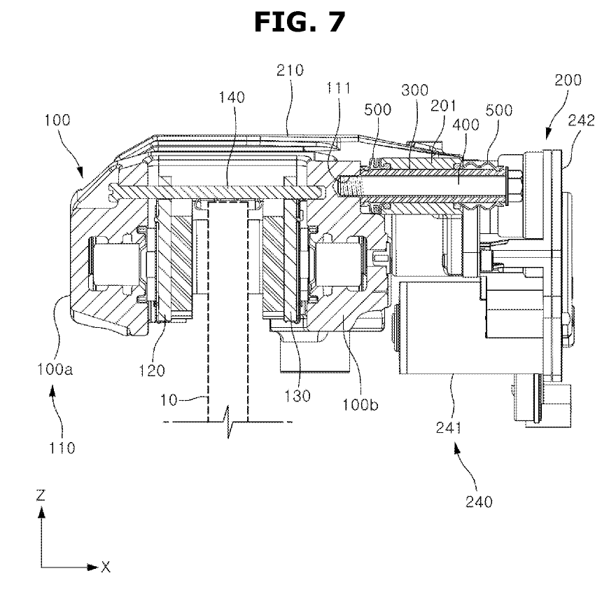

FIG. 7 is a cross-sectional view taken along line VII-VII IN FIG. 1.

Referring to FIGS. 1-7, the guide rod 300 may be inserted into the guide 201 to guide movement of the parking braking part 200.

The guide rod 300 may be formed in a hollow cylindrical shape, and may be formed to have a shape extending along the direction parallel to the first direction. The guide rod 300 may be inserted into the guide 201 to guide movement of the parking braking part 200 in the first direction or in the direction opposite to the first direction. That is, the parking caliper body 210 may be slidably movable along an axial direction of the guide rod 300 parallel to the first direction.

The fastening member 400 may be fastened to the service braking part 100 by passing through the guide rod 300. The fastening member 400 may be coupled to the service braking caliper body 110 by passing through an interior of the guide rod 300 in the direction parallel to the first direction. Accordingly, the parking caliper body 210 may be supported on the service braking caliper body 110. The fastening member 400 may be exemplified by a bolt or the like.

The brake apparatus for a vehicle according to the present embodiment may further include a dust boot 500.

The dust boot 500 may be coupled to the guide 201, and may be disposed on both sides of the guide rod 300 parallel to the first direction. The dust boot 500 may include an elastically deformable material such as rubber, silicone, or plastic.

The dust boot 500 may prevent an entry of external foreign substances into an interior of the guide 201, and may provide a fluid-tight seal for the interior of the guide 201. The dust boot 500 may prevent rattle noise during movement of the parking caliper body 210.

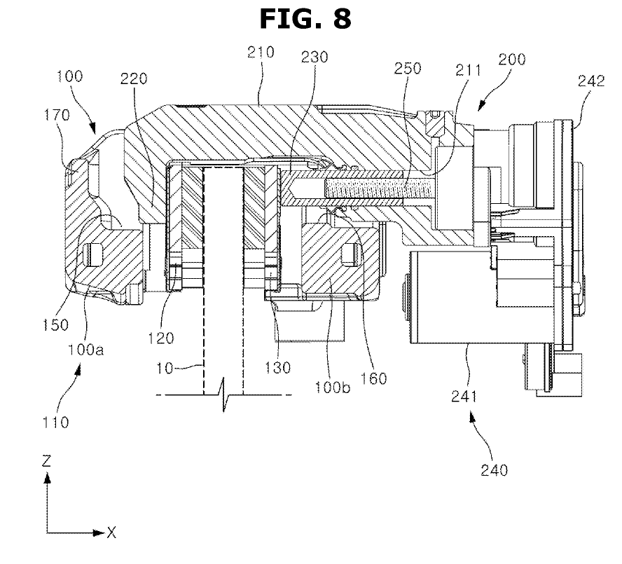

FIG. 8 is a cross-sectional view illustrating an operating state of the brake apparatus for a vehicle according to embodiments of the present disclosure.

Referring to FIG. 8, in response to the drive unit 240 operating, rotational force generated from the motor 241 is transmitted, through the power transmission means 242, to the power transmission member 250 disposed inside the parking cylinder 211; and then in response to the power transmission member 250 rotating about its axis, the parking piston 230, which is movably coupled to the power transmission member 250, moves in the direction opposite to the first direction inside the parking cylinder 211 and presses the second brake pad 130.

As the parking piston 230 moves in the direction opposite to the first direction, the second brake pad 130, which is disposed to face the parking piston 230, may move in the direction opposite to the first direction due to the pressing of the parking piston 230 and come into contact with the brake disc 10; and the parking caliper body 210 may be guided by the guide rod 300 to move in the first direction due to reaction force generated between the parking piston 230 and the second brake pad 130.

As the parking caliper body 210 moves in the first direction, the finger 220, which is disposed to face the first brake pad 120, may press the first brake pad 120 in the first direction, such that the first brake pad 120 may come into contact with the brake disc 10.

The brake apparatus for a vehicle according to embodiments of the present disclosure may implement an electronic parking brake (EPB) that uses a fixed-type caliper for service braking to enhance braking performance and uses a floating-type caliper to operate parking braking.

The brake apparatus for a vehicle according to embodiments of the present disclosure may utilize the service braking caliper body 110 as a torque member of the parking caliper body 210 during parking braking.

The brake apparatus for a vehicle according to embodiments of the present disclosure may replace the guide rod 300 of a conventional Colette (CL)-type with the guide rod 300 of a Colette Reverse (CR)-type structure to connect the service braking caliper body 110 and the parking caliper body 210, thereby securing a stable center of gravity and enhancing behavioral stability of the parking caliper body 210 to improve durability and dynamic braking performance.

Although the present disclosure has been described with reference to the embodiments illustrated in the drawings, the embodiments are merely for illustrative purposes, and those skilled in the art will appreciate that various modifications and other equivalent embodiments are possible from the embodiments. Therefore, the true technical scope of the present disclosure should be defined by the following claims.

What is claimed is:

1. A brake apparatus for a vehicle, the brake apparatus comprising:
a service braking part;
a parking braking part movably disposed in the service braking part and provided with a guide;
a guide rod inserted into the guide to guide movement of the parking braking part in a first direction or in a direction opposite to the first direction; and
a fastening member fastened to the service braking part by passing through the guide rod.

2. The brake apparatus of claim 1, further comprising a dust boot coupled to the guide and disposed on both sides of the guide rod.

3. The brake apparatus of claim 1, wherein the service braking part comprises:
a service braking caliper body;
a first brake pad movably disposed in a first region of the service braking caliper body and configured to contact the parking braking part; and
a second brake pad movably disposed in a second region, configured to face the first region, of the service braking caliper body and configured to contact the parking braking part.

4. The brake apparatus of claim 3, wherein the service braking part further comprises a guide pin provided in the service braking caliper body, wherein the first brake pad and the second brake pad are movably coupled to the guide pin, such that the guide pin guides movement of the first brake pad and the second brake pad.

5. The brake apparatus of claim 3, wherein the service braking caliper body comprises:
a first groove concavely recessed in the first region to expose at least a portion of the first brake pad; and
a second groove concavely recessed in the second region to expose at least a portion of the second brake pad.

6. The brake apparatus of claim 5, wherein the service braking caliper body further comprises a movement restricting portion provided in the first region and configured to interfere with the parking braking part and restrict movement of the parking braking part in the direction opposite to the first direction.

7. The brake apparatus of claim 3, wherein the parking braking part comprises:
a parking caliper body provided with a parking cylinder disposed to face the second brake pad;
a parking piston movably disposed in the parking cylinder and configured to contact the second brake pad;
a drive unit coupled to the parking caliper body and configured to generate rotational force; and
a power transmission member rotatably disposed in the parking cylinder and configured to receive the rotational force from the drive unit and move the parking piston.

8. The brake apparatus of claim 7, wherein the parking piston is coupled to the power transmission member and moves in the first direction or in the direction opposite to the first direction in response to rotation of the power transmission member.

9. The brake apparatus of claim 8, wherein the parking piston moves in the direction opposite to the first direction to press the second brake pad.

10. The brake apparatus of claim 7, wherein the parking braking part comprises a finger configured to extend from the parking caliper body, disposed to face the first brake pad, and configured to press the first brake pad in response to the parking caliper body moving in the first direction.
